(19) United States
(12) Patent Application Publication
(10) Pub. No.: US 2014/0074828 A1
(43) Pub. Date: Mar. 13, 2014

(54) SYSTEMS AND METHODS FOR CATALOGING CONSUMER PREFERENCES IN CREATIVE CONTENT

(71) Applicant: MYEMPTYSLATE, INC., New York, NY (US)

(72) Inventor: Anshul Mathur, New York, NY (US)

(73) Assignee: MyEmptySlate, Inc., New York, NY (US)

(21) Appl. No.: 13/831,510

(22) Filed: Mar. 14, 2013

Related U.S. Application Data
(60) Provisional application No. 61/700,278, filed on Sep. 12, 2012.

(51) Int. Cl. G06F 17/30

(52) U.S. Cl. CPC G06F 17/30554
USPC 707/723

(57) ABSTRACT

Systems, methods, and computer-readable media are provided for consumers to better understand their preferences for attributes in entertainment content and enable smarter search and discovery of content. Embodiments support a mapping system showing a consumer's preference mix for specific attributes of entertainment content (e.g. plot, characters, theme, voice, conflict, resolution, and the like). Embodiments of the invention also provide for systems and methods that use identification schema to create a library of entertainment content online and subsequently record and match consumer preferences for attributes in entertainment content online. Various ways are also provided to automatically synchronize, obtain, and update entertainment content online on the source(s) and/or the client device.

### CROSS-REFERENCE TO RELATED APPLICATIONS

This application claims the benefit of the following provisional application, which is hereby incorporated by reference in its entirety: U.S. Provisional App. No. U.S. 61/700,278 filed Sep. 12, 2012.

### INCORPORATION BY REFERENCE

All publications, including patents and patent applications, mentioned in this specification are herein incorporated by reference in their entirety to the same extent as if each individual publication was specifically and individually indicated to be incorporated by reference.

### FIELD OF THE INVENTION

The present application relates generally to computer implemented systems and methods for consumers to better understand their preferences for attributes in entertainment content and enable smarter search and discovery of content. More specifically, the present invention provides systems and methods that use identification schema to create a library of entertainment content online and subsequently record and match consumer preferences for attributes in entertainment content online.

### BACKGROUND OF THE INVENTION

Systems and methods have been developed for analyzing elements of entertainment content for comparative purposes such as, for example, identifying text with similar styles, or identifying texts with different styles, or ranking those differences on a spectrum, etc. Netflix is service whereby a user identifies movies that he previously viewed and along with indicating a level of his satisfaction with the movies. By doing so Netflix is able to then provide the user with recommendations for movies with similar styles or genres based on the various levels of his indicated satisfaction with the movies he indicated as having previously viewed.

Discovering a new movie based on the pattern in the style of movies previously viewed, discovering a new musical group based on a type of musical preference, or discovering a new book based on similar subject matter, is very useful and has been well received by consumers. However, several aspects of these systems and methods need improvement.

These existing systems that make recommendations on entertainment content to a user, be it for movies, music, books, and the like, typically rely on probabilistic models of behavior based on historical ratings of content entered by the user. In these systems consumers are required to rate the unit of entertainment content (e.g. a book or movie) as a whole. This method of collecting ratings ignores consumer preferences for specific attributes of the content. The attributes of the entertainment content are defined by the constituent elements which can include, but are not limited to, language difficulty, point of view, tone, portrayal of reality, plot, themes, categories, time to read, recommended ages, characters, voice, conflict, setting, and resolution. For instance, an attribute of a unit of entertainment content in which a user can have a preference for may be the setting of the story such as “an urban environment” or a particular theme in the story such as “romance.” These attribute preferences are missed in a system where ratings are assigned to the content as a whole. Therefore, a need exists to adequately capture consumer preferences at the level of constituent elements of the content in order to make powerful recommendations that match a consumer's individual preferences for specific attributes of the entertainment content.

Typical recommendation systems often employ a tagging-based classification system. Such systems and methods for classifying entertainment content are limited to basic content attributes. They typically have shallow classification methodology, often disorganized, which limits the value in codifying consumer tastes. Consumer taste goes beyond merely genres, but extends to the specific constituent elements (e.g. story, character types, themes, setting, etc.). Categories and genres that are not mutually exclusive limit meaningful segmentation of consumer preferences, thereby limiting the value in powering a recommendation engine.

What's more, prior recommendation systems do not provide consumers with the ability to actively modify attributes to provide customized recommendations in real-time. These systems typically hide their classification and mapping system from the consumer. Thus, the entertainment content attributes are typically not viewable or adjustable to consumers.

Prior recommendation systems also lack functionality to analyze relationships between entertainment content across different types, e.g. movies, books, music, live performance events, etc. Most systems are limited to classifying entertainment content to a single domain, e.g. books. This limits the ability to understand consumers' preferences in entertainment content. Prior recommendation systems miss capturing a more precise understanding of an individual's entire universe of preferred entertainment choices—books, movies, short stories, documentaries, television programs, live performance events, podcasts, and the like. Consequently, the ability of prior systems to provide users with the ability to explore entertainment content of different types with a single search and discovery interface is limited.

Accordingly, the present invention improves upon these recommendation systems. Described herein are new systems and methods for data normalization in the form of a codified database of content with detailed maps of underlying attributes for every unit of entertainment content (e.g. a book or movie) across different types of entertainment content. The use of a systematic mechanism of identifying content attributes which can be accessible and adjustable by the consumer based on their own personal tastes is the primary differentiator from any prior systems. There are additional aspects of one or more embodiments that also differentiate the present invention from prior systems. They will become apparent as this specification proceeds.

### SUMMARY OF THE INVENTION

The systems and methods disclosed herein allow users to classify attributes in entertainment content by the constituent elements (herein referred to as TorchWords) using identification schema referred to as TorchWord Maps to create a library (also referred to throughout as a database) of entertainment content online. The systems and methods facilitate the recording and matching of consumer preferences for attributes in entertainment content. Upon identifying preferences for attributes in entertainment content, the user may receive recommendations for entertainment content that have the user's preferred attributes.

In an exemplary method, recommendations for entertainment content are made by utilizing a computer processing system for determining at least one matching unit of entertainment content that corresponds to at least one source unit of entertainment content. A database that comprises data relative to various entertainment content is provided wherein the computer processing system can electronically access the database. Either by a human or by a computer profiles can be generated for entertainment content based on the data relative to it. Such profile records the attributes of the entertainment content. The computer processing system recognizes and analyzes the data in the profiles about the attributes of the entertainment content. Each unit of entertainment content can be digitally configured to display one or more retrieved units of entertainment content from content sources of different types in a format specified by a publisher of each unit of entertainment content. A user can receive entertainment content recommendations based on attributes associated with profiles for units of entertainment content designated or previously consumed by the user. The profiles for units of entertainment content designated or previously consumed by the user are search criteria. The search criteria can be generated by direct user input or automatically by a computer. The computer compares the categories associated with profiles for units of entertainment content to a user's search criteria to determine intersecting categories. The comparison determines a score based a measure of similarity between the categories associated with the profiles for units of entertainment content and the search criteria. Recommendations for entertainment content are presented to the user based on the intersecting categories where the score exceeds a ranking threshold.

In an exemplary system, a repository of identified entertainment content is created by a user and maintained. The repository of content is created by collecting information on entertainment content from informational sources on Internet websites, databases, online publications, user inputs, etc. The information in the repository includes the bibliographic information, such as author, title, language as well as information about the entertainment content's constituent elements.

Additional features of exemplary embodiments are described below. Where not defined otherwise, all technical and scientific terms used herein have the same meaning as commonly understood by one of ordinary skill in the art of this invention. The materials, methods, and examples provided herein are not intended to be limiting and are only presented for illustrative purposes.

### BRIEF DESCRIPTION OF THE DRAWINGS

In order to show how the invention may be carried into effect, embodiments of the invention are now described below by way of example only and with reference to the accompanying figures in which:

FIG. 1 is a high level diagram of a network for implementing an embodiment of the present system and method;

FIG. 2 is a diagram of a computing environment for use in the disclosed embodiments;

FIG. 3 is a block diagram depicting functional components of a server machine:

FIG. 4 is a flow chart of a process for assigning TorchWords over a network;

FIG. 5 depicts an example of a TorchWord set for a unit of entertainment content for a book;

FIG. 6a is a flow chart of one contemplated embodiment of the system and method of analyzing and categorizing (process for assigning a TorchWord set to) a unit of entertainment content) to determine levels of similarity between different units of entertainment content;

FIGS. 6b and 6c depict examples of similarity between entertainment content;

FIG. 7 is a flow chart of a process for matching content based on TorchWord sets;

FIG. 8 is a flow chart of a process by which a user creates a TorchBox based on entertainment content the user has experienced:

FIG. 9 depicts an example of the information that may be hosted in a TorchBox.

### DETAILED DESCRIPTION

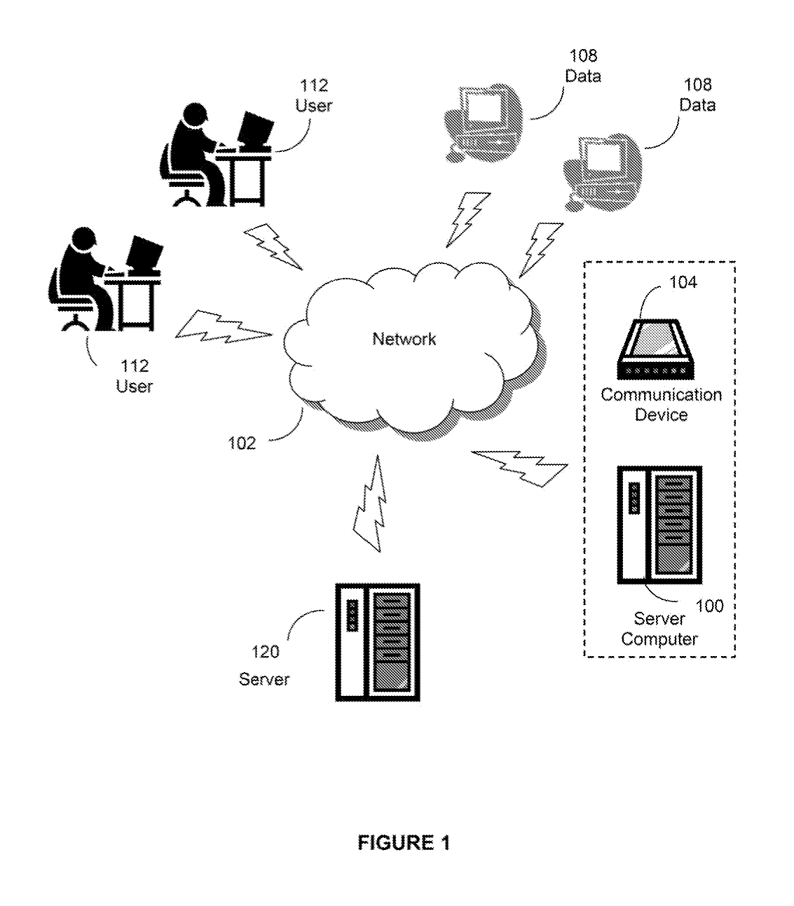

Illustrative embodiments described below with reference to FIGS. 1 through 9 depict systems and methods for using identification schema to create a library of entertainment content online then record and match consumer preferences for attributes in entertainment content online. It will be appreciated by those of ordinary skill in the art that the description given herein with respect to those figures is for exemplary purposes only and is not intended in any way to limit the scope of the potential embodiments. While the exemplary system is described with respect to collecting, analyzing, and searching online data, the system likewise could be applied to collect, analyze, and search data related to data that is online as well not online, but has information describing it available online.

To assist the reader, the following terms are used in this specification and should be understood to have the following meanings, unless otherwise specified or made clear by the context.

### DEFINITIONS

Entertainment content, or simply content, includes, but is not limited to reading material (e.g. fiction and non-fiction books, magazine articles, literary journals, short stories), audio material (e.g. podcasts, audio-books, radio shows, talks), video material (e.g. movies, television shows, documentaries) and events (e.g. live performance events, comedy shows, theater, storytelling, book readings, book launches, film events) and the like. The entertainment content or information about it can be accessible online through the Internet, also commonly referred to as the WorldWideWeb. It is important to point out that the entertainment content itself is only available online sometimes (e.g. electronic books or streaming movies). Some content, particularly older content, are available only in the physical format and not online. What's more, events as defined above typically occur in the real world, as opposed to online.

TorchBug™ refers to the computer-implemented system, methods and processes for creating and utilizing using identification schema to create a library of entertainment content online then record and match consumer preferences for attributes in entertainment content. The identification schema for a specific unit of entertainment content is created from the process of establishing a set of structured attributes that define a unit of entertainment content. TorchBug™ allows for data normalization in the form of a codified database of identification schema across a wide spectrum of entertainment content. A matching engine associates similarity amongst the normalized data in the database as part of the searching and matching functions which operate on that database. The matching engine employs an algorithm to effectively calculate the similarities between different content within the database. Algorithms define relationships between different content and at any lime the database can provide a weighted similarity ratio between any two units of entertainment content (e.g. how similar is a specific book to a specific movie). The TorchBug™ then sorts the results to yield an adjustable number of proximate matches.

A library refers to a codified database of information about the entertainment content including underlying attributes (i.e. TorchWords) of the content.

A TorchWord refers to an attribute or element that helps describe a unit of entertainment content. Constituent TorchWords can include, but are not limited to, difficulty, point of view, tone, portrayal of reality, story, themes, categories, time needed, recommended ages, characters, voice, conflict, setting, and resolution. The definitions of the constituent TorchWords are discussed further below.

TorchWord Map refers to the identification schema—e.g. category, themes, conflict, etc. The identification schema of a unit of entertainment content captures its attributes. The identification schema is the profile of the entertainment content.

A TorchTag refers to a keyword or term assigned to a unit of entertainment content that helps describe an item and allows it to be found again by browsing or searching. A TorchTag is additional metadata to describe the content. TorchTags are generally chosen informally and personally by the item's creator or by its viewer.

The “Category” TorchWord refers to whether the entertainment content is either fiction or nonfiction. All content must be assigned a category before other TorchWords can be assigned.

The “Recommended Age” TorchWord refers to the age of the consumer who would most likely be consuming the content. For instance, kids describes ages 0-9 years old, tweens describes ages 10-12 years old, teens describes ages 13-20 years old and adult is over 20 years old. The recommended age TorchWord can be used for both fiction and non-fiction content.

The “Difficulty” TorchWord refers to easy, medium commitment, and high commitment. Commitment is meant to be interpreted as the amount of mental concentration an average consumer of text, video or audio with a secondary school level of education must exert. For written work (or text), difficulty is determined by reading grade level. For audio, video and events it is a subjective assessment done by the person creating TorchWords for the content. In a preferred embodiment, only one description of the difficulty element can be selected. The difficulty TorchWord can be used for both fiction and non-fiction content.

The “Time Needed” TorchWord refers to the time needed to completely consume the entertainment content. If it is a book (or written work) and the time needed to read the book completely book takes longer than 40 minutes to complete, the time needed would be long. Conversely, if the time needed to complete the book is 40 minutes or less then the time required to complete it is regarded as short. With a different type of entertainment content, the rule still applies. If it is a movie and the time needed to view the entire movie from start to finish takes less than 40 minutes, then the time needed would be designated as short whereas anything that takes longer than 40 minutes to completely consume would be designated as long. The time needed TorchWord can be used for both fiction and non-fiction content.

A “Tone” TorchWord describes the overall mood conveyed by the content (e.g. a book or movie). Tones can be selected from positive, dark, absurd, logical, humorous, serious and poignant. Tone TorchWords can be elected in multiple and can be used for both fiction and non-fiction content.

A “Point of view” TorchWord is composed of first person, second person, third person omniscient and third person limited and can be used for both fiction and non-fiction content. Only one description of the point of view TorchWord can be selected.

The following TorchWords apply only to non-fiction content—purpose and subjects and represent attributes unique to non-fiction (e.g. a memoir or documentary film).

The “Purpose” TorchWord is used for nonfiction only and refers to the creator's or writer's intent for the content. TorchWords for purpose are composed of storytelling, exposition, persuasion and description.

The “Subject” TorchWord is used for nonfiction only and refers to the primary topic of the content. Subject TorchWords can include, but are not limited to, arts, sports, business & finance, environment & nature, food, history, religion & spirituality, politics, human behavior & society, technology, occupations, economics, leisure, philosophy, science & mathematics, armed conflict, entertainment, medicine & health, games, gender & feminism, architecture & engineering, design and music.

The following TorchWords apply only to fiction content—story reality, story type, story conflict, story settings, story protagonist, theme, subtheme and TorchTags.

A “Story Reality” TorchWord describes the state of things as they exist in the content, or as they may appear or might be imagined. Therefore, the TorchWords for reality are composed of realism, magical realism, surrealism, fantasy, and science fiction. With the reality attributes at least one, and only one, attribute is allowed to be selected.

A “Story Type” TorchWord classifies the content as a quest, voyage and return, rebirth, comedy, tragedy, overcoming the monster or rags to riches, one and only one story type attribute must be selected.

A “Story Conflict” TorchWord describes a struggle between opposing forces, such as man vs. man, man vs. self, man vs. society, man vs. the supernatural and man vs. destiny.

“Story setting” TorchWords are grouped by place, time, occupation and society. Multiple attributes for the story setting are allowed.

Within the story setting attributes of place, the following attributes can be selected: urban, suburban, wilderness, multiple and indeterminate.

Within the story setting attributes of time, the following attributes can be selected: pre-historic, ancient, middle ages, early modern era, modern era, post-modern era, future eras, multiple and indeterminate.

Within the story setting attributes of occupation, the following attributes can be selected: law, armed forces, investigation agencies, police forces, political/government, corporate, medical, academic, multiple and indeterminate.

Within the story setting attributes of society, the following attributes can be selected: contemporary society, poverty, society in conflict, dictatorship, utopia, dystopia, multiple and indeterminate.

The “Story protagonist” TorchWord describes the primary character. The story protagonist attribute elements are grouped by age and gender. Within the story protagonist attributes of age, the following attributes can be selected: kids, tweens, teens, early twenties, middle age, older adults, old and indeterminate.

Within the story protagonist attributes of gender, the following attributes can be selected: male, female, other and indeterminate. At least one story gender option must be selected.

The “Theme” TorchWords describe the primary theme of the story. The following attributes can be selected: mystery, thriller, horror, romance, drama, adventure, coming of age and human condition. Multiple options can be selected. At least one option for a primary theme TorchWord must be selected.

The “SubTheme” TorchWords describe the secondary themes of the story. The following attributes can be selected: redemption, morality, mortality, faith, love, courage, fear, pride, jealousy, anger, suffering, gender inequality, socio-economic disparity and discrimination. Multiple options can be selected.

A TorchTag is a label assigned as either specific character types in a story (e.g. superhero, zombie, famous people) or a specific style of telling a story (e.g. violence, animation).

FIG. 1 is a high level diagram of the exemplary system for users 112 to classify entertainment content using identification schema referred to as TorchWords to create a library of entertainment content online, then record and match consumer preferences for attributes in entertainment content. Server 100 is a computing system that collects, analyzes, and provides access to data. Server 100 operates as a database server and a hypertext transfer protocol server and may comprise a single computing machine or a plurality of computers.

Data source servers 108 are computing systems that operate as repositories of data. The repositories may include both public and private sources.

Network 102 may be any electronic computer processing network including the Internet. User terminals 112 provide users with access to server 100 via network 102 and communications device 104. User terminals 112 may be personal computers, laptop computers, hand-held computing systems, wireless phones, or any other suitable computing device having either a wired or wireless connection to the network 102. User terminals 112 are generally loaded with Internet browser software such as Netscape Navigator, Mozilla Firefox, or Microsoft Explorer and are operable to communicate over network 102 to download data including Internet web pages from server 100.

Server 120 is a server machine that provides a gateway to information on entertainment content such as the information about the entertainment content found online (i.e. on the Internet). Server 120 provides an interface to the user interface or system through which user preferences are captured or requests for recommendations are routed. Server 120 may be operable to interface with a network such as an electronic communication network (ECN).

Generally, server 100 communicates with data source servers 108 to gather data related to entertainment content. After downloading data from the data source servers 108, server 100 calculates values for various user-defined searching parameters. With respect to the exemplary embodiment, server 100 derives matches for potential screening parameters that may be used to screen for entertainment content with preferred attributes. Server 100 then stores the data and the values for the searchable screening parameters so as to have such data available for making recommendations for entertainment content. This collection of data may be referred to as a repository or database of entertainment content data. The computer processing system which can include the data source servers, computer user interface, servers, networks and the like, are enabled to electronically access said database.

By using a computer users can access the database. Thereby, users access server 100 over network 102 to search the database for entertainment content that possess attributes which align with either user defined search strategies or user profiled attribute preferences on the entertainment content. Upon identifying a particular search strategy, a user may issue a request through an electronic communication device to execute a request for recommendations for entertainment content with specific attributes. The request is routed from user terminal 112 to server 100. Server 100 forwards the request over network 102 to Server 120 where the matching is executed.

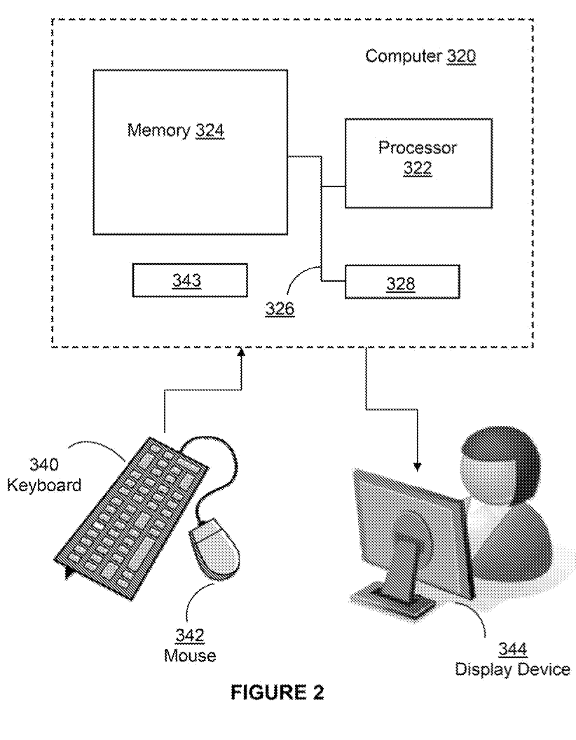

Server computer 100, data servers 108, server 120, and user terminals 112 are generic computing systems. FIG. 2 is a block diagram of an exemplary computing system in which embodiments of the present invention, or portions thereof, may be implemented as computer-readable code. The components or modules of the system, may be implemented in one or more computer systems using hardware, software, firmware, tangible computer-readable media having instructions stored thereon, or a combination thereof and may be implemented in one or more computer systems or other processing systems. Modules and components in FIGS. 1-9 may be embodied in hardware, software, or any combination thereof.

As shown, computing device 320 includes processing unit 322, system memory 324, and system bus 326 that couples various system components including system memory 324 to the processing unit 322. Computing devices, such as mobile devices or producer server, may include one or more processors, one or more non-volatile storage mediums, one or more memory devices, a communication infrastructure, a display screen and a communication interface.

Processor 322 can be programmed with instructions to interact with other computing systems so as to perform the algorithms and serve the web pages described below with reference to FIGS. 1 through 9. The instructions may be received from network 102 or stored in memory 324 and/or hard drive 328. Processor 322 may be loaded with any one of several computer operating systems such as, for example, Windows NT, Windows 2000, or Linux. Processors may include any conventional or special purpose processor, including, but not limited to, digital signal processor (DSP), field programmable gate array (FPGA), application specific integrated circuit (ASIC), and multi-core processors. A specialized processor may also be included that executes instructions and programs, selected for complex graphics and mathematical operations, in parallel.

The system memory 324 may include one or more volatile memory devices such as but not limited to, read only memory (ROM) and random access memory (RAM). Communication infrastructure may include one or more device interconnection buses such as Ethernet, Peripheral Component Interconnect (PCI), and the like.

The system might further include hard-drive 328, which provides storage for computer readable instructions, data structures, program modules and other data. Non-volatile storage may include one or more of a hard disk drive, flash memory, and like devices that may store computer program instructions and data on computer-readable media. One or more of non-volatile storage device may be a removable storage device.

Typically, computer instructions are executed using one or more processors and can be stored in non-volatile storage medium or memory devices.

A user may enter commands and information into the computer 320 through input devices such as a keyboard 340 and pointing device 342.

A monitor 344 or other type of display device is also connected to the system for output. Display screen allows results of the computer operations to be displayed to a user or an application developer.

Communications device 343, which may be, for example, a modem, provides for communications over network 102. Communication interface allows software and data to be transferred between computer system and external devices. Communication interface may include a modem, a network interface (such as an Ethernet card), a communications port, a PCMCIA slot and card, or the like. Software and data transferred via communication interface may be in the form of signals, which may be electronic, electromagnetic, optical, or other signals capable of being received by communication interface. These signals may be provided to communication interface via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

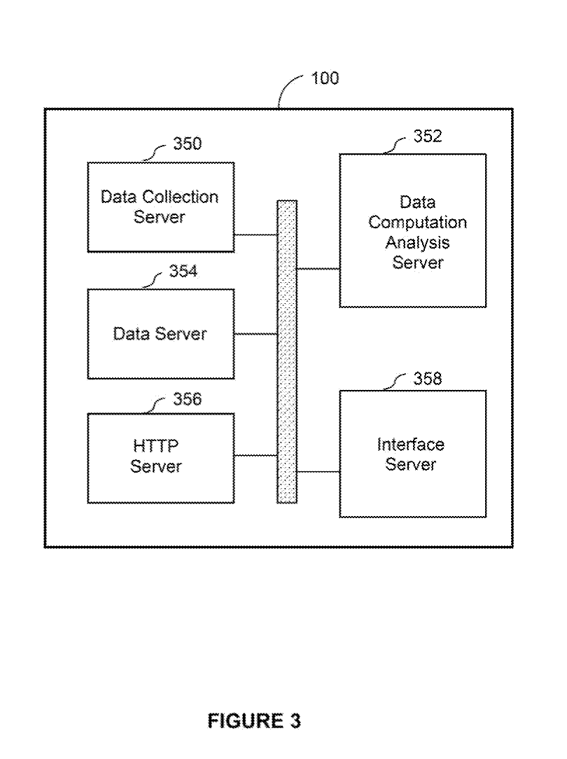

FIG. 3 is a diagram of the functional components of server 100. As shown, server 100 comprises data collection server 350, data computation/analysis server 352, database server 354, hypertext transfer protocol (HTTP) server 356, and interface server 358. Data collection server 350 operates to download content data from data servers 108. Data computation/analysis server 352 operates to compute searchable content screening parameters from the content data. Database server 354 maintains and provides access to the content data and searchable parameters. Database server 354 maintains a repository of content data and searchable parameters for entertainment content. Database server 354 may comprise any of numerous commercial database software systems such as those produced by Oracle Corporation and Microsoft Corporation. Database server 354 handles queries of the content data and searchable content screening parameters. HTTP server 356 maintains hypertext markup language (HTML) pages, serves dynamic HTML objects, and provides fault tolerance and load balancing. HTTP server 356 may comprise any of several well-known HTTP server software systems, such as, for example, the Windows NT server produced by the Microsoft Corporation. It should be noted that server 100 might comprise a single computing machine or a plurality of computing machines. Furthermore, data collection server 350, data computation/analysis server 352, database server 354, HTTP server 356, and brokerage interface server 358 may be comprised in a single software server and further may be located on a single computer system. As depicted in FIG. 3, servers 352, 354, 356, and 358 are operable to communicate with each other as necessary.

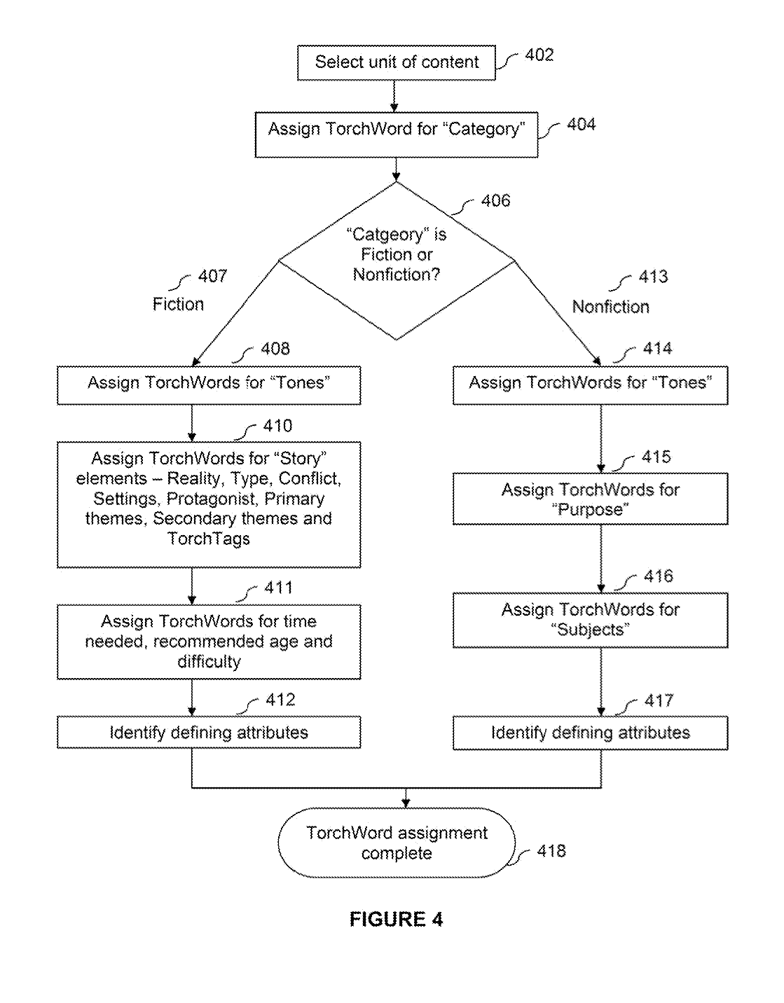

FIG. 4 provides a flow chart of a process performed by user 112 for assigning a TorchWord set to a unit of content. Here a profile for one or more units of entertainment content is generated based on the data relative to the one or more units of entertainment content. The profile records the attributes of the one or more units of entertainment content by categories. Through an electronic communication device, more specifically a computer, and a graphical user interface (GUI) the user 112 first establishes a connection to network 102 if one does not already exist. At step 402, user 112 selects a unit of content. The unit of entertainment content selected is not limited to written works; it can be any of the assorted types of entertainment content described above.

The profile for the entertainment content is stored in the database where it can be accessed by a user through a computer. The computer recognizes the data in the database as a profile containing one or more attributes of said entertainment content. Further analysis can be performed by a computer of a plurality of profiles for one or more units of entertainment content.

In an exemplary system, the unit of content relates to a book, such as “Harry Potter and The Goblet of Fire.” Accordingly, the data may comprise the following: at step 406, user 112 selects if the “Category” is fiction or nonfiction. If the user 112 selects the “Category” to be fiction 407, at step 408 the user 112 then assigns TorchWords for the “Tone” of the content. After the “Tone” has been assigned, user 112 assigns TorchWords for the “Story” elements 410 such as, for example, reality, type, conflict, settings, protagonist, primary themes, secondary themes, and TorchTags. In an exemplary embodiment of the disclosed system, the category for “Harry Potter and The Goblet of Fire” is fiction and the tone is dark.

Next, the amount of time need to complete the reading of the content. “Harry Potter and The Goblet of Fire,” as well as the recommended age of the reader and the difficulty level of reading are indicated by the user 112. Once user 112 completes the assignment of these TorchWords at step 411, the next step 412 is to define any further attributes called TorchTags that help to distinguish the content. In one embodiment, for example, “Harry Potter and The Goblet of Fire” is given the TorchTag of “series” to indicate the story is part of a series of stories. By way of another example, the movie “Batman Begins” is given the TorchTag of “superhero” to indicate the story is based on a comic book superhero character.

Referring back to FIG. 4, if at step 406, the unit of entertainment content selected by the user is not fiction, the “Category” would then be identified by the user 112 as nonfiction 413. Thus, as shown in FIG. 4, the process proceeds to step 414 where the user 112 assigns TorchWords for the “Tone” of the content. If the unit of entertainment content is a biography about the former United States President Abraham Lincoln, the tone could be inspiring, historical, and tragic. After the “Tone” has been assigned, user 112 assigns TorchWords for the “Purpose.” In the instance of this current example about a biography on President Abraham Lincoln, the purpose would be educational. At step 416, user 112 assigns TorchWords for the “Subject” of the content, which in this case would be President Abraham Lincoln, but not necessarily limited to just one subject. At step 417, any defining attributes can further be identified.

Defining attributes are the attributes of the entertainment content (i.e. TorchWords) that make it distinctive. Defining attributes are not required to be designated but defining attributes will lead to more accurate categorization as well as more precise searching and matching results. For instance, in the story—“A Christmas Carol” by Charles Dickens, the “Story Reality” attribute would be “Fantasy” and the “Theme” attribute would be “Redemption”. Of the two—“Redemption” is a better characterization of the story than “Fantasy”. “Redemption” could then be labeled as a “defining attribute”.

Defining attributes can be optionally designated when TorchWords are assigned to entertainment content. The assignment of TorchWords for specific content can be executed manually by a user or a curator, or through computer based machine analytics such as a text analytics software program that is commercially available. Text analytics involves the process of structuring the input text (usually parsing, along with the addition of some derived linguistic features and the removal of others, and subsequent insertion into a database), deriving patterns within the structured data, and finally interpretation of the output. Tasks include text categorization, text clustering, concept/entity extraction, production of granular taxonomies, sentiment analysis, document summarization, and entity relation modeling (i.e., learning relations between named entities).

When a set of TorchWords are designated as a defining attributes, the algorithm can be optionally set to use only the designated defining attributes in matching with similar content and in search results. The decision of including or excluding defining attributes will depend on specific use-cases of the TorchWord schema and algorithm, for example a dating site may want to use the TorchWord schema to get a map of tastes and preferences of its audience based on the likes and dislikes for books and movies. In this case the defining attribute may be excluded to provide a complete list of audience tastes based on TorchWords. As a second example, an education site may want to use the TorchWord schema to provide quick synopses of books and movies for students. In this case including the defining attribute provides a more accurate picture of relationships between different books and movies for further analysis.

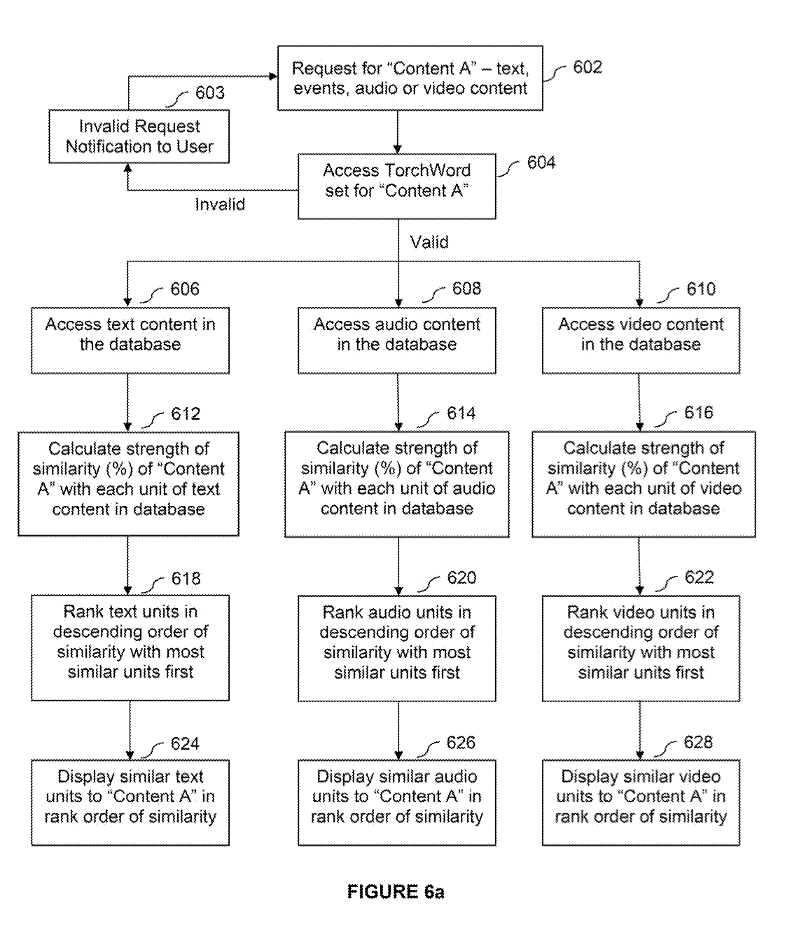

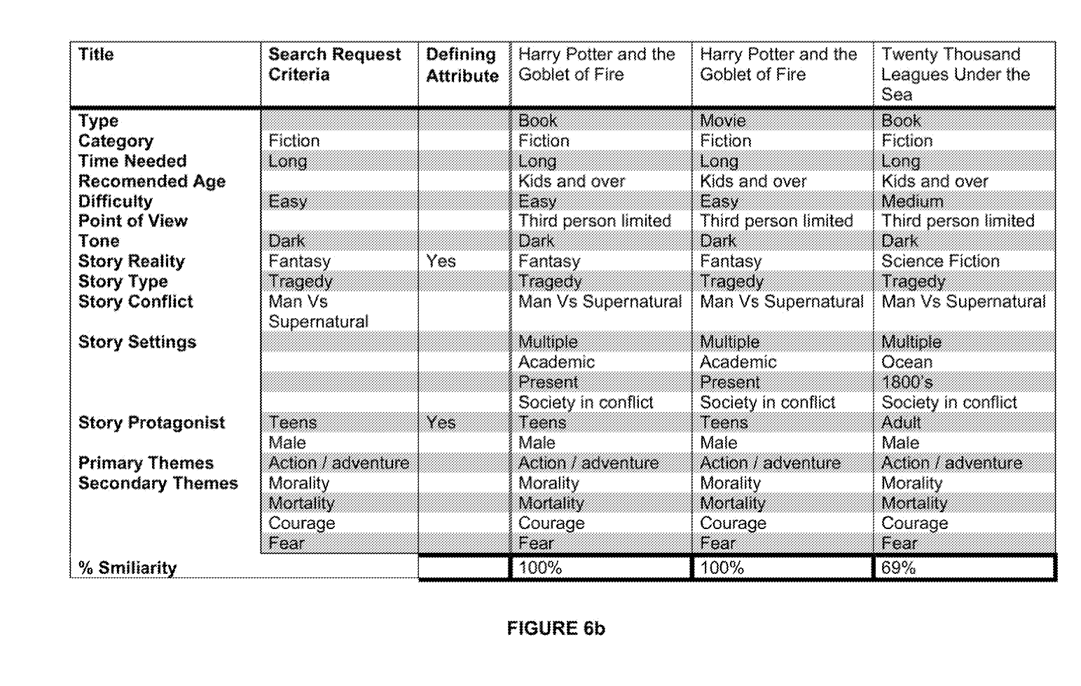

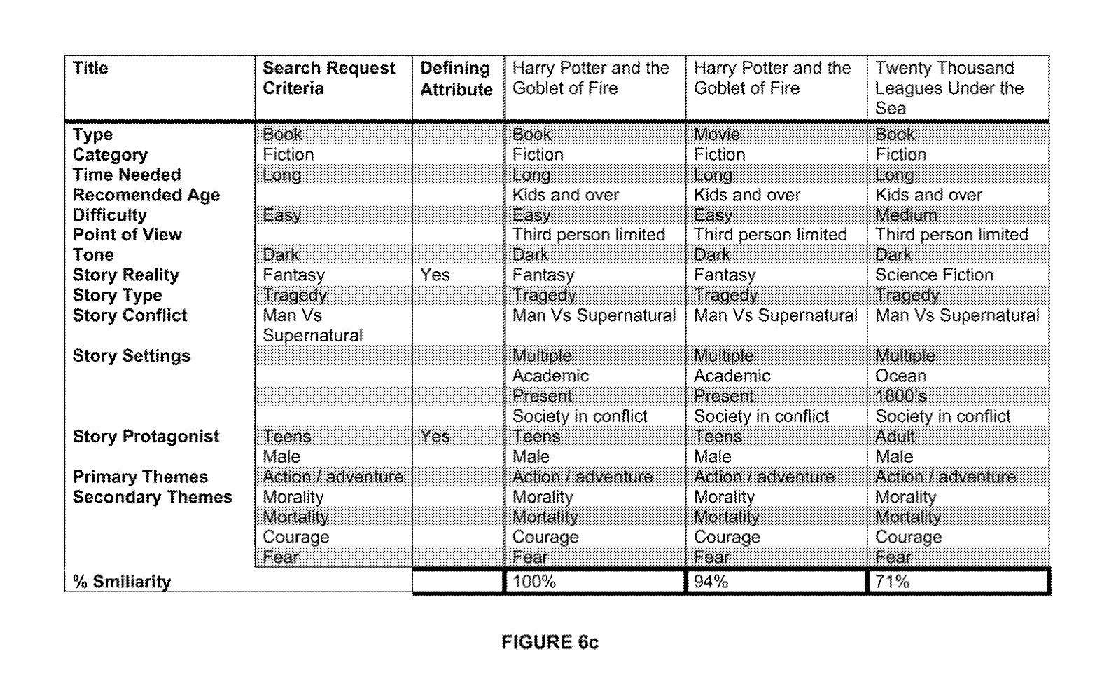

The weights for the categories may be assigned alphabetically by selecting radio button, customized by the user by selecting radio button, or automatically suggested based on a user profile of the user by selecting radio button. If alphabetical weighting is selected, the weights are assigned by alphabetically sorting the categories and assigning a weight to each of the categories based on its position in the alphabetically sorted list of categories. As illustrated in FIG. 6a, if customized weighting is selected, the user may be presented with a GUI for customizing the weighting of the categories. As illustrated in the exemplary embodiment of FIG. 6a, the weights of the categories may be assigned by user election or analysis of user trends in entertainment consumption. Note that the attribute types “Category”, “Time Needed” and “Recommended Age” do not receive weights. Instead, these TorchWords are treated as filters to directly match content. For example if a book is assigned a “Category” of “Non-fiction”—the similarity algorithm only matches this book with other content (books or movies) with a category of “Non-fiction”.

Once the weights are assigned, a similarity calculation is performed.

Referring back to FIG. 4, at step 418, the assignment of TorchWords is complete and the data about the unit of entertainment content is normalized. This data is saved to server 100 preserve it for use in building the library and user searching. Server 100 uses the information classified by TorchWords to derive matching strategies for a plurality of screening parameters. If at step 418 additional data updates are received, the system can perform an update at any time from the user 112 who classified the information on the unit of content, or another authorized user.

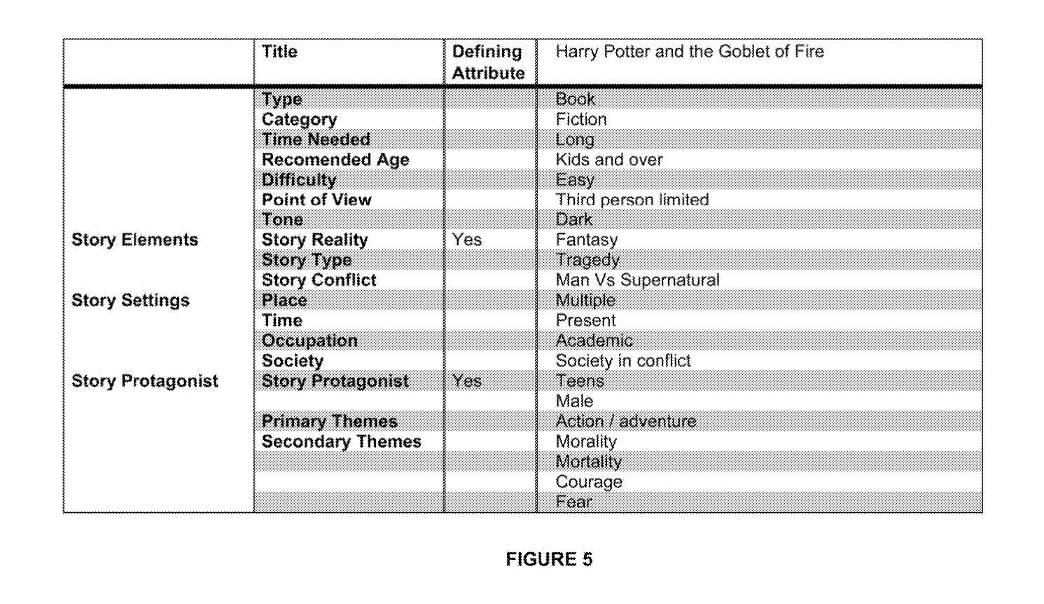

FIG. 5 is an exemplary screen that may be used to input the desired TorchWords for the classification process. In the case of the Harry Potter example previously described, “Harry Potter and The Goblet of Fire,” it can be further classified according to its story elements, story settings and story protagonist. The story reality is fantasy. The story type is tragedy and the story conflict is man versus supernatural. The story settings are comprised of place, time, occupation and society. Since the Harry Potter story is set in multiple locations, the place is multiple. The time is present. The occupation is academic. The society is contemporary society. The story protagonist is comprised of age, gender, primary themes and secondary themes. The Harry Potter character in this example is a teenage boy so the TorchWords assigned are teens for age and male for gender. The TorchWords assigned for the primary themes are action/adventure. The secondary themes assigned are courage, mortality, fear and morality. The amount of time needed to complete this book is long. The recommended age for the average reader to which this book would appeal is kids and over. The difficulty assigned to this book reflects the reading level and it is assigned as easy.

Referring back to FIG. 4, at step 418, this process would occur for every new unit of content that a user 112 classifies. The result is the creation of a library of data on entertainment content that has been normalized using the assignment of TorchWords. From this library of classified entertainment content, manual searches can be performed to identify similar content. Also a computer can generated recommendations automatically based on user's entertainment content preferences and consumption habits.

An exemplary process of matching similar content is depicted in the flowchart in FIG. 6a. Either when a user 112 enters new content into the database after assigning TorchWords or users at terminals 112 define a search requesting content, a matching process occurs by a computer matching entertainment content based on TorchWord sets.

As an embodiment of the present invention, a user can receive recommendations for entertainment content based on entertainment content the user indicates as having consumed, and designating a level of interest in recommendations for similar entertainment content.

Furthermore, a user profile can be generated and stored in the database which includes attributes associated with units of entertainment content the user has viewed, consumed, selected or indicated as preferred by the user.

The process for designating a level of interest in receiving recommendations for similar entertainment content can be implemented by computer through a variety of data collection methods commonly employed by one of skill in the art. An exemplary method is using questionnaires based on likes and dislikes of attributes of entertainment content. Another method of determining a user's preferences in entertainment content can include a computer tracking the entertainment content the user has indicated as having consumed and the computer finding similarities across that entertainment content. The similarities in entertainment content can be predictive in determining recommendations of potential entertainment content the user may enjoy based on the number of intersecting categories in the profiles for the entertainment content.

FIG. 6a depicts a process in which the attributes of entertainment content a user has indicated as having consumed can be used to identify similar entertainment content to recommend to the user. As shown in FIG. 6a, at step 602 a user at terminals 112 indicates to server 100 what content the user has just consumed, i.e. “Content A.” The information for “Content A” represents the type or types of content which the system will next search, i.e. text, events, audio, or video content. A user's 112 information designating Content A having been consumed is received by the server 100.

As shown in FIG. 6a, after the user's request is received, at step 604, server 100 parses the user defined values to determine if the values entered by the user are logical and operable for searching the database. For example, the TorchWord set for “Content A” is accessed. Accordingly, if at step 604, it is determined that the values entered by the user are not valid, at step 603, server 100 transmits a notification of such to the user. If the user-defined values are valid, however, the server 100 searches the database of data for Content A. This searching step is similar for all the different types of content, i.e. text, events, audio, video, etc. In the exemplary embodiment of FIG. 6a, the server accesses all of the different types of entertainment content, for instance, text content in the database 606, audio content in the database 608, video content in the database 610, and the like. The strength of the similarity of “Content A,” with each unit of text content in the database 612, each unit of audio content in the database 614, each unit of video content in the database 616, etc., is calculated by a computer.

A unique aspect of the present system and method disclosed herein is the ability to find similarities in entertainment content across the different types of entertainment content, not just by singular type. For example, the similarity in a book talk event and a movie because both the book talk event and the movie had many intersecting categories in their profiles. In a preferred embodiment, the strength of the similarity is expressed as a percentage wherein 0% similarity means there is no similarity between Content A and the specified database content, and 100% means that the similarity is so strong it is a precise match for Content A.

The results of the search are then ranked according to percentage similarity. In a preferred embodiment, the most similar results with the user-defined search values for Content A are presented first and descend to the search results that have the least percentage of similarity. Shown in FIG. 6a for the text, audio and video as steps 618, 620 and 622 respectively.

In another embodiment, a user can indicate if there is a preference for a type of entertainment content, such as books-on-tape are preferred over movies, events are preferred over movies, short books are preferred over long books, etc.

Referring back to FIG. 6a, at steps 624, 626 and 628, server 100 formats the results of the database search for viewing via a web browser and transmits the results to the user, usually formatted as a web page. The results include the list of content (i.e. text, audio, video, etc.) that could be recommended to the user as entertainment content that has strong similarity to the entertainment Content A which the user just indicated to the server 100 as having consumed. In a preferred embodiment, the user can also indicate a level of satisfaction with Content A which will serve as a means of training the system for matching data across the database.

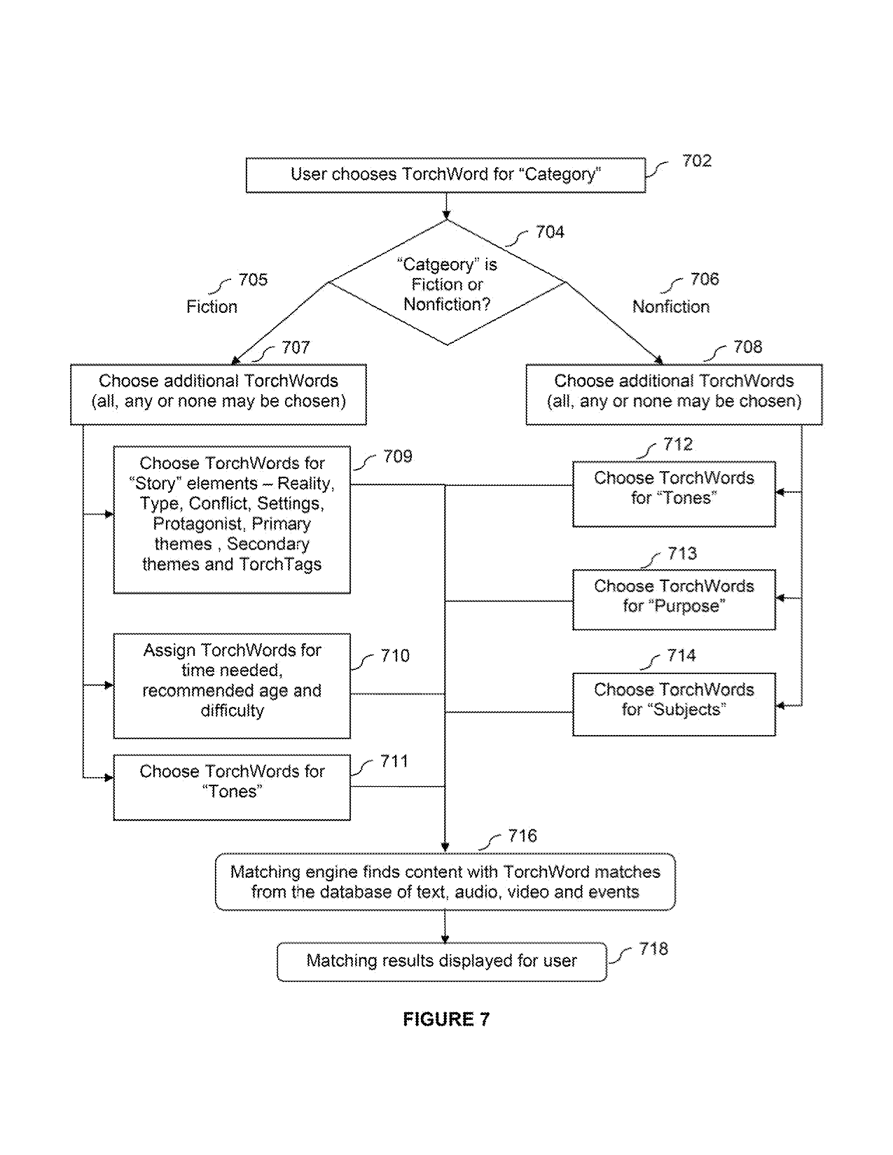

FIG. 7 provides a flow chart of a process performed by user 112 for searching for content based on TorchWord sets. At step 702 users at terminals 112 may issue requests to server 100 to search for content by choosing a TorchWord. The TorchWord or TorchWords comprised in a user's 112 request may vary, but may comprise, for example, to search for content by choosing a TorchWord for “Category,” i.e. fiction 705 or nonfiction 706 at step 704. The request may be received at, for example, HTTP server 356.

The user could select the search criteria at step 602 for as many categories as the user deems necessary for a thorough search. However, the more criteria that the user defines in the search request, the more targeted the search and the more narrow the recommendations will be that the user receives as a result of the search. For instance, the user's request criteria may limit the search by specific type of content, such as books only, in which the search results would be limited to only the content that is in book or text format. Alternatively, the default search results will not limit the type of the content and return values such as movies, books, audio and events.

If the user 112 chooses “Fiction 705” for the TorchWord Category, at step 707, user 112 may add more search parameters by choosing additional attributes (i.e. TorchWords) to narrow the search results. This is an elective step in the process, so all, some or no additional Attributes may be selected by user 112. If user 112 does select additional Attributes, the additional Attributes can be used to focus the search by story elements, step 709, such as reality, type, conflict, settings, protagonist, primary themes, secondary themes and TorchTags. At step 710, the user 112 can also focus the search by defining the amount of time needed to consume the content, the recommended age associated with the consumer of the content and the difficulty associated with consuming the content. In addition, at step 7111, Attributes for tones of content can also be defined in the user's 112 search parameters.

If the user 112 chooses “Nonfiction 706” for the TorchWord Category, at step 708, user 112 may add more search parameters by choosing additional Attributes to narrow the search results. Similar to as described above with a choice of “Fiction 705,” this is an elective step in the process. All, some or no additional Attributes may be selected by user 112. If user 112 does select additional Attributes to further focus the search parameters amongst the Nonfiction 706 content, additional Attributes for tones, purpose and subjects exemplify which nonfiction that Attributes may help the user to better define the search parameters.

At step 716, the matching engine performed by a computer identifies content in the database with Attributes that match the user-defined search criteria. This matching engine is a computer. It can employ a multi-layer search tool, which is understood by one of skill in the art to be based on an algorithm, that finds the content that has the Attributes indicated by the user. The normalized data in the database can be on entertainment content including text, audio, video and events (i.e. live performances). The computer calculates a score based on the number of attributes which are the same between at least one profile for unit of entertainment content and the search criteria. The score determined by a computer is based on attributes across a plurality of categories in a profile.

When the search criteria is met, the computer identifies the profile of the entertainment content that has attributes which meet a search criteria. If more than one profile for a unit of entertainment content meets a search criteria, the identification of multiple profiles of entertainment content can be ranked according to minimum threshold value for the score. This can also be understood as the results of the search are then ranked by the computer according to percentage similarity. In a preferred embodiment, the most similar results with the user-defined search values for Content A are presented first and descend to the search results that have the least percentage of similarity. The following tables illustrate how the similarities can be determined.

| | | Movie | | | |
|---|---|---|---|---|---|
| | | Harry Potter - | Book | All Common | Common Defining |
| Attribute Type | Weight | Goblet of fire (“A”) | Alice in Wonderland (“B”) | Attributes | Attributes |
| Category | NA | Fiction | Fiction | | |
| Time needed | NA | Long | Long | | |
| Recommended age | NA | Kids | Kids | | |
| Point of view | 0.9 | Third person limited* | Third person limited* | Third person limited* | Third person limited* |
| Difficulty | 2 | Easy* | Easy* | Easy* | Easy* |
| Tones | 2 | Positive* | Absurd* | | |
| | 2 | Dark* | — | | |
| Story Reality | 2 | Fantasy* | Magical Realism* | | |
| Story Type | 1 | Tragedy | Voyage & Return* | | |
| Story Conflict | 1 | Man vs Supernatural | Man vs Supernatural | Man vs Supernatural | |
| Setting - Place | 1 | — | — | | |
| Setting - Time | 1 | — | Modem Era | | |
| Setting - Occupation | 3 | Academic* | — | | |
| Setting - Society | 2 | Society in conflict | — | | |
| Protagonist Age | 1 | Teens* | Kids* | | |
| Protagonist Gender | 1 | Male* | Female* | | |
| Themes | 2 | Action/adventure* | Action/adventure* | Action/adventure* | Action/adventure* |
| | 2 | — | Drama* | | |
| | 2 | — | Coming of Age* | | |
| SubThemes | 1 | Morality* | Morality* | Morality* | Morality* |
| | 1 | Morality* | Morality* | Morality* | Morality* |
| | 1 | Courage* | Courage* | Courage* | Courage* |
| | 1 | Fear | — | | |
| TorchTags | 3 | — | — | | |
| | Score | 23.5 | 20.5 | 8.5 | 7.5 |

Similarity using ALL Attributes
How similar is B to A?
Similarity Ratio (as X) × 30X
How similar is A to B?
Similarity Ratio (as X) × 41X
Similarity using Defining
Attributes only
How similar is B to A?
Similarity Ratio (as X) × 32X
How similar is A to B?
Similarity Ratio (as X) × 37X
*= Indicates Defining Attribute

An exemplary equation employed by a computer for matching a particular unit of entertainment content based on similarity to another unit of entertainment content without using defining attributes is:

$$Similarity B to A = ( \frac{Common attributes}{Attributes of A} ) \times 100 = ( \frac{8.5}{23.5} ) \times 100 = 36 \%$$

$$Similarity A to B = ( \frac{Common attributes}{Attributes of B} ) \times 100 = ( \frac{8.5}{20.5} ) \times 100 = 41 \%$$

An exemplary equation employed by a computer for matching a particular unit of entertainment content based on similarity to another unit of entertainment content using defining attributes is:

$$Similarity B to A = ( \frac{Common attributes}{Attributes of A} ) \times 100 = ( \frac{7.5}{23.5} ) \times 100 = 32 \%$$

$$Similarity A to B = ( \frac{Common attributes}{Attributes of B} ) \times 100 = ( \frac{7.5}{20.5} ) \times 100 = 37 \%$$

As part of the disclosed systems and methods, search criteria can be refined to generate refined search results based on different criteria. For example a user may want to start by finding content that is “Fiction”, “Long form” and for “Kids”. This search would provide a listing of all units of entertainment content (e.g. books and movies) that match these three criteria. The user may then want to refine their expectations further by designating “Difficulty Type” as “Easy”, designating the “Theme” as “Action/adventure” and the “SubThemes” as “Morality”, “Mortality” and “Courage”. This stepwise filtering system performed by a computer leads to a narrow set of results matching the exact criteria specified by the user. The table below illustrates the results of such a search.

| | | Results | |
|---|---|---|---|
| User entered choices | | Movie | Book |
| | Attribute | Harry Potter - | Alice in |
| Attribute Type | Name | Goblet of Fire (“A”) | Wonderland (“B”) |
| Category | Fiction | Fiction | Fiction |
| Time needed | Long | Long | Long |
| Recommended | Kids | Kids | Kids |
| age | | | |
| Point of view | — | Third person | Third person |
| | | limited* | limited* |
| Difficulty | Easy | Easy* | Easy* |
| Tones | — | Positive* | Absurd* |
| | — | Dark* | — |
| Story Reality | — | Fantasy* | Magical Realism* |
| Story Type | — | Tragedy | Voyage & Return* |
| Story Conflict | — | Man vs Supernatural | Man vs Supernatural |
| Setting - Place | — | — | — |
| Setting - Time | — | — | Modem Era |
| Setting - | — | Academic* | — |
| Occupation | | | |
| Setting - Society | — | Society in conflict | — |
| Protagonist Age | — | Teens* | Kids* |
| Protagonist | — | Male* | Female* |
| Gender | | | |
| Themes | Action/ | Action/adventure* | Action/adventure* |
| | adventure | | |
| | — | — | Drama* |
| | — | — | Coming of Age* |
| SubThemes | Morality | Morality* | Morality* |
| | Morality | Morality* | Morality* |
| | Courage | Courage* | Courage* |
| | — | Fear | — |
| TorchTags | — | — | — |

The user is provided entertainment content recommendation by displaying to a user through a computer device if at least one profile for a unit of entertainment content satisfies the search criteria, as show in step 718. At step 718, server 100 formats the results of the database search for viewing via a web browser and transmits the results to the user, usually formatted as a web page. The results include the list of content (i.e. text, audio, video, events, etc.) that satisfy the user-defined query, providing the entertainment content recommendation includes providing one or more user identified units of entertainment content that matches a user defined preference for one or more attributes of entertainment content. The entertainment content recommendations can also include providing one or more user identified units of entertainment content that matches a user defined preference for one or more attributes of entertainment content.

In a preferred embodiment, the user may digitally link to, access, subscribe to, purchase or learn more information about the entertainment content corresponding to the recommendation when the recommendation is provided to the user by a computer.

In another embodiment, the recommendation process can involve search criteria that are not explicitly user defined. For instance, the recommendation process can be driven based on the frequency of attributes occurring in entertainment content consumed by a user. This is an example of an automated recommendation process relying merely on the inputs of the user regarding the entertainment content that he has consumed, viewed, selected or indicated as preferred. The computer performs at least one method of text analytics on the user inputs including information retrieval, lexical analysis to study word frequency distributions, pattern recognition, tagging/annotation, information extraction, or data mining techniques. Data mining technique can include link and association analysis, visualization, and predictive analytics.

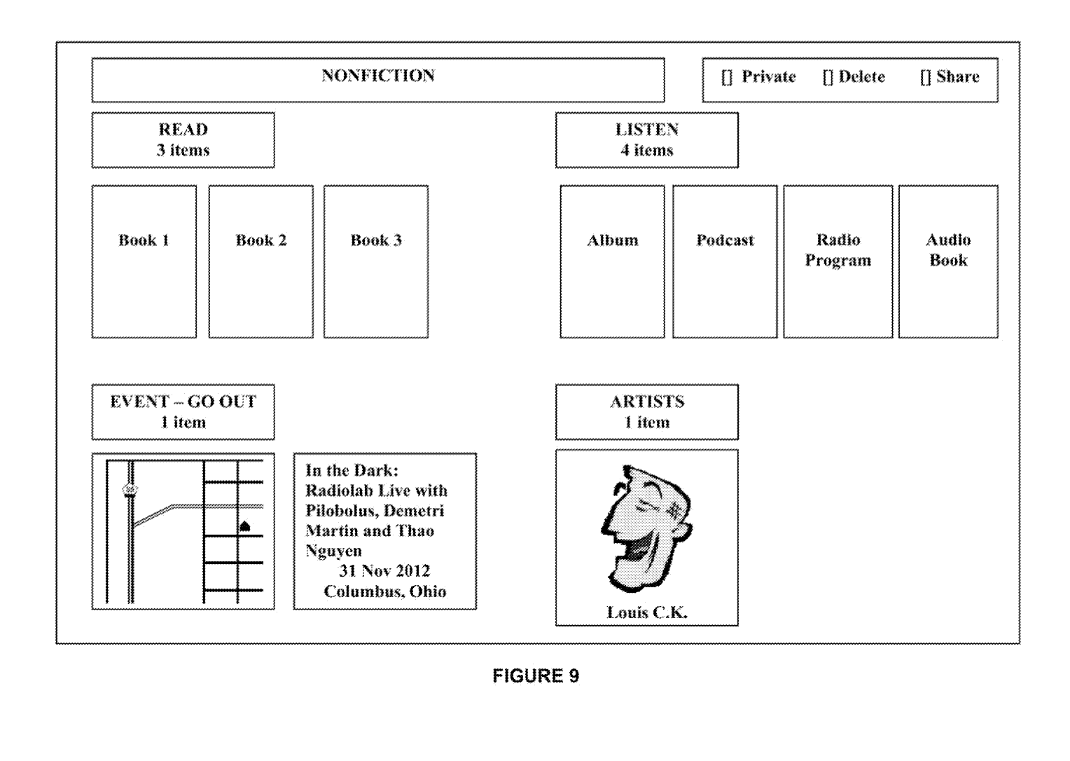

Another aspect of the disclosed systems and methods allows for the creation and maintenance of a repository stored in a database and accessible through a GUI of a communication device. This repository is herein referred to as a TorchBox. Creating a TorchBox allows a user 112 to aggregate content according to the user's 112 defined purpose. A user may create a TorchBox by selecting particular content from a list of results such as is shown in FIG. 9. Examples of a purpose can include but are not limited to: keeping track of content that is of interest to the user either for future consumption, reference or making record of it as being already viewed, read, attending, listened to, etc., step 812. Keeping notes on what the user 112 thought of the content can also be also a purpose, step 810. The user 112 may also have the purpose of publicly disclosing what content the user has consumed (or intends to consume), step 814. Also, the user's 112 opinion of the content, such as if the user 112 liked or disliked the content can be, shared with others, step 818. The process of sharing with others can include, but is not limited to, sharing information electronically via email or posting to a website via the internet and GUI, step 820. The TorchBox, in its entirety, or in part, does not have to be shared publicly. Information on the user's 112 TorchBox can be kept from being made publicly available, step 816. These various purposes of the information contained on the TorchBox can be interchanged and used in tandem.

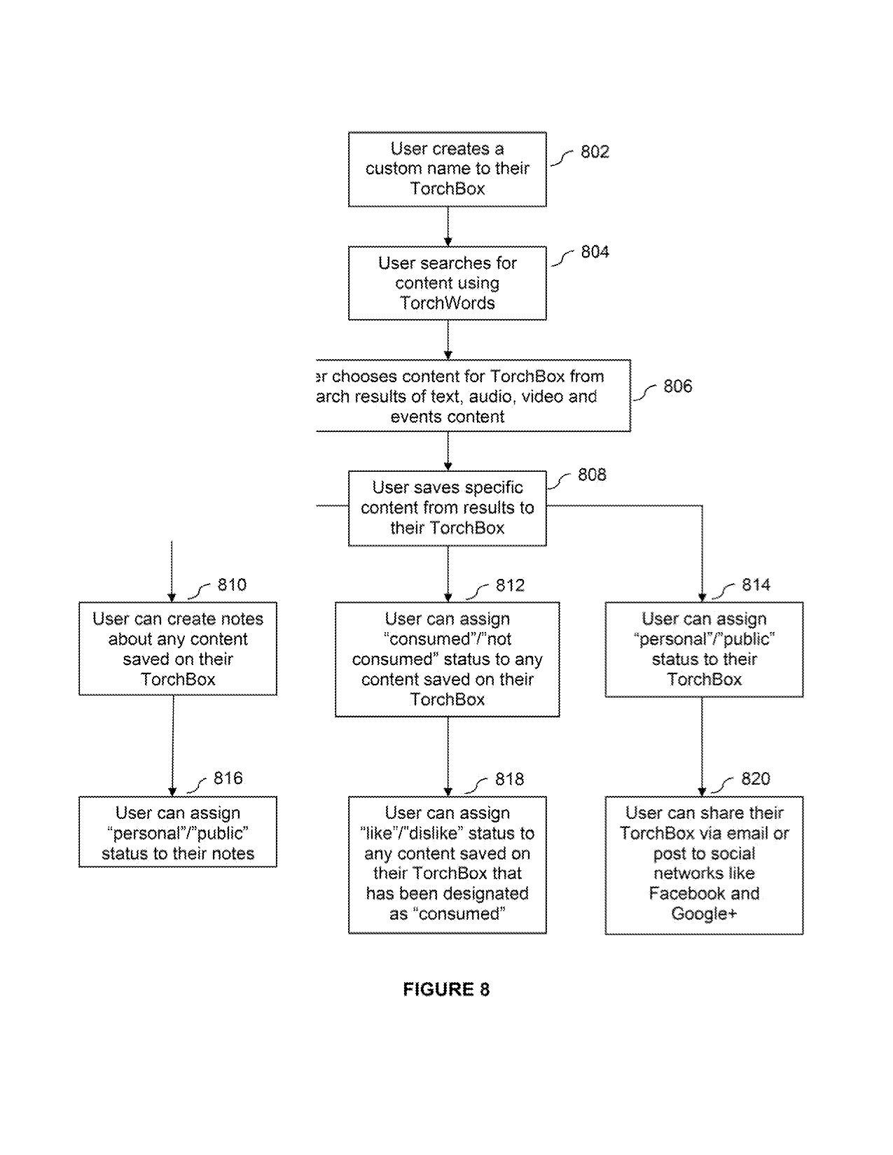

FIG. 8 is a flowchart of how a user may create and use a TorchBox. At step 802, the user 112 access the server 100. The user 112 may create a name for his TorchBox. At step 804, the user 112 searches for content including, but not limited to, text, audio, video, and event content, by using TorchWords. When a user 112 requests a search, the request is performed through a GUI and computer, which gets forwarded to server 100. Server 100 processes the request by retrieving the percentage returns using the database. The results are forwarded across the network to the user's 112 GUI or workstation. At step 806, the user 112 may then select which content to add to his TorchBox based on the searches performed and the results presented. Through the GUI the user 112 may then save specific content results to his TorchBox, step 808.

An exemplary screen for presenting data relating to a TorchBox is shown in FIG. 9. In the exemplary screen of FIG. 9, the data presented shows a TorchBox as an illustrative web page that may be used to transmit the results of a search back to the requestor.

Thus, exemplary systems and methods for classifying, searching and aggregating content have been disclosed. The disclosed systems and methods allow users to keep a repository of the content that has the greatest relevance to them. Thus, a user may optimize their search criteria using established preferences on content attributes, and then apply their search criteria and strategies to identify opportunities for discovering new content.

Those skilled in the art understand that computer readable instructions for performing the above described processes and presenting the above described screens, such as those described with reference to FIGS. 1 through 9, can be generated and stored on a computer readable medium such as a magnetic disk or CD-ROM. Further, a computer such as that described with reference to FIG. 2 may be arranged with other similarly equipped computers in a network, and each computer may be loaded with computer readable instructions for performing the above described processes.

While the systems and methods have been described and illustrated with reference to specific embodiments, those skilled in the art will recognize that modification and variations may be made without departing from the principles of the exemplary embodiments as described above and set forth in the following claims. The disclosed systems and methods could be applied to gather, save and make accessible for searching units of entertainment content and add their own custom information to the unit. As an example, a user can assign whether the entertainment content has been consumed or not consumed, make a personal note about any entertainment content, write a review about any entertainment content, and provide a review, such as a verdict of like or dislike, thumbs up or thumbs down, rating on a sale of 1-5 from least favorite to most preferred, etc., on any entertainment content.

Still further the disclosed systems and methods may be used to allow users to share the entertainment content they have saved as well as the related user generated data with other users of the system or even externally across the Internet.

The system also allows users to follow different users, allow other to follow them, and view the saved units and the related user generated data of other users in the system.

Accordingly, reference should be made to the appended claims as indicating the scope of the potential embodiments.

What is claimed is:

1. A method for analyzing entertainment content comprising:
providing a computer processing system for determining at least one matching unit of entertainment content based on a similarity of attributes between at least one unit of entertainment content;
providing a database that is comprised of data relative to one or more source units of entertainment content;
said computer processing system being enabled to electronically access said database;
accessing said database by a computer;
generating a profile for one or more units of entertainment content based on the data relative to the one or more units of entertainment content, wherein the profile records the attributes of the one or more units of entertainment content by categories;
storing said profile in said database;
recognition by a computer of the data as a profile containing one or more attributes of said entertainment content:
analysis performed by a computer of a plurality of profiles for one or more units of entertainment content;
comparing said profiles for units of entertainment content by categories, wherein the comparing further comprises:
calculation by a computer of a score based on the number of attributes which are the same between at least one profile for unit of entertainment content and a search criteria, wherein the score is based on attributes across a plurality of categories in a profile; and
identification by a computer of at least one profile for a unit of entertainment content that has attributes which meet a search criteria, wherein if more than one profile for a unit of entertainment content meets a search criteria the identification of the plurality of profiles can be ranked according to minimum threshold value for the score; and
providing at least one entertainment content recommendation by displaying to a user through a computer device if at least one profile for a unit of entertainment content satisfies the search criteria.

2. The method of claim 1, wherein the search criteria is defined by a user or by an automated process performed by a computer.

3. The method of claim 1 wherein attributes of the entertainment content includes language difficulty, point of view, tone, portrayal of reality, plot, themes, categories, time to read, recommended ages, characters, voice, conflict, setting, and resolution.

4. The method of claim 1, further comprising enabling the user to digitally link to, access, subscribe to, purchase or learn more information about the entertainment content corresponding to the recommendation.

5. The method of claim 1, wherein the analyzing includes assigning at least one weight to an attribute, and wherein the comparing includes combining the attribute weight and assigning a ranking.

6. The method of claim 1, wherein the search criteria is based on a frequency of attributes occurring in entertainment content consumed by a user.

7. The method of claim 1, further comprising generating a profile of a user that includes attributes associated with units of entertainment content viewed, consumed, selected or indicated as preferred by the user.

8. The method of claim 1, wherein providing the entertainment content recommendation includes providing one or more user identified units of entertainment content that matches a user defined preference for one or more attributes of entertainment content.

9. The method of claim 1, wherein providing the entertainment content recommendation is displayed to the user in an order according to ranking of the score calculated by a computer.

10. A system for providing entertainment content recommendations comprising:
an attribute analyzer executing on a computer processor and configured to:
analyze a plurality of attributes identified based on one or more units of entertainment content, each of the one or more retrieved units of entertainment content associated with one or more categories in one or more units of entertainment contents; and
generate a entertainment content profile for each entertainment content based on categories of the plurality of categories identified for one or more retrieved articles of the corresponding entertainment content;
generate a profile of a user that includes categories associated with articles in the one or more retrieved entertainment contents viewed by the user, and
a recommendation provider configured to: compare the categories associated with entertainment content profiles to categories of a profile of a user to determine intersecting categories, wherein to compare the categories the recommendation provider is further configured to:
determine a matching score based on the similarity between the categories associated with the entertainment content profiles and the generated user profile, wherein the matching score is based on a function for determining the similarity between the categories; and identify the intersecting categories where the matching score exceeds a ranking threshold; and
provide a entertainment content recommendation for display by a computer to the user based on the comparing of the categories associated with entertainment content profiles to the categories of the profile of the user.

11. The system of claim 7, wherein the user may digitally link to, access, subscribe to, purchase or learn more information about the entertainment content corresponding to the recommendation.

12. The system of claim 7, wherein the attribute analyzer is configured to assign a weight to each attribute of the plurality of categories, combine the attribute weights and assign a ranking.

13. The system of claim 7, wherein the attribute analyzer is further configured to search for entertainment contents based on the user profile.

14. The system of claim 10, wherein the recommendation provider is further configured to provide entertainment content selected based on the entertainment content profile.

15. The system of claim 7, wherein the user profile is also based on entertainment contents previously consumed by the user.
